(19) United States
(12) Patent Application Publication
(10) Pub. No.: US 2024/0388851 A1
(43) Pub. Date: Nov. 21, 2024

(54) SPEAKER APPARATUS

(71) Applicant: JVCKENWOOD Corporation, Yokohama-shi (JP)

(72) Inventors: Yusuke ISHIKAWA, Yokohama-shi (JP); Kazuyuki INAGAKI, Yokohama-shi (JP)

(21) Appl. No.: 18/790,512

(22) Filed: Jul. 31, 2024

Related U.S. Application Data
(63) Continuation of application No. PCT/JP2022/033771, filed on Sep. 8, 2022.

(30) Foreign Application Priority Data
Feb. 24, 2022 (JP) 2022-026613

(51) Int. Cl. H04R 7/18

(52) U.S. Cl. CPC H04R 7/18; H04R 2400/11

(57) ABSTRACT

A speaker apparatus according to the present invention is a speaker apparatus including an edge that is provided around a diaphragm and that causes the diaphragm to vibrate in a sound emission direction, a frame that is provided around the edge and that supports the diaphragm via the edge, and a linear reinforcement part that is provided on the edge. The reinforcement part extends in a circumferential direction of the edge, and two end portions of the reinforcement part are connected to the frame.

### CROSS REFERENCE TO RELATED APPLICATION

This application is a continuation application of PCT/JP2022/033771, filed Sep. 8, 2022, which is based upon and claims the benefit of priority from Japanese patent application No. 2022-026613, filed on Feb. 24, 2022, the disclosure of which is incorporated herein in its entirety by reference.

### BACKGROUND

The present invention relates to a speaker apparatus.

A general speaker apparatus generates sound by causing a diaphragm to be vibrated by a voice coil. The diaphragm is supported by a frame via an edge that is provided at a periphery. When operating normally, the diaphragm vibrates in a sound emission direction of the speaker apparatus.

Japanese Unexamined Patent Application Publication No. 2021-158684 discloses a speaker apparatus where buckling deformation of an edge is suppressed by ribs provided in the edge. The rib disclosed in Patent Literature 1 extends from inside toward outside in a radial direction of the edge.

### SUMMARY

With a general speaker apparatus, a phenomenon called a rolling motion may occur where a vibration component in a different direction from a normal drive direction is added at a specific frequency at a time when a diaphragm is driven. The rolling motion may become a cause of an abnormal sound and should be suppressed. However, with a general speaker apparatus, the rolling motion was not sufficiently suppressed.

Japanese Unexamined Patent Application Publication No. 2021-158684 does not disclose a technique that is capable of solving such a problem.

A speaker apparatus according to the present embodiment is
a speaker apparatus including:
an edge provided around a diaphragm;
a frame configured to support the diaphragm via the edge; and
a reinforcement part provided on the edge, the reinforcement part including a linear portion and two end portions,
in which the linear portion of the reinforcement part extends in a circumferential direction of the edge, and the two end portions of the reinforcement part are connected to the frame.

### BRIEF DESCRIPTION OF THE DRAWINGS

The above and other aspects, advantages and features will be more apparent from the following description of certain embodiments taken in conjunction with the accompanying drawings, in which:

FIG. 1 is a perspective view showing a speaker apparatus according to a related art;

FIG. 2 is a schematic cross-sectional view for describing a shape of an edge according to the related art;

FIG. 3A is a schematic perspective view for describing a rolling motion of a diaphragm;

FIG. 3B is a schematic perspective view for describing a rolling motion of a diaphragm;

FIG. 4 is a perspective view showing a speaker apparatus according to a first embodiment;

FIG. 5 is a schematic cross-sectional view for describing a shape of an edge according to the first embodiment;

FIG. 6 is a schematic cross-sectional view for describing the shape of the edge according to the first embodiment;

FIG. 7 is a schematic cross-sectional view showing the speaker apparatus according to the first embodiment;

FIG. 8 is a schematic plan view showing the speaker apparatus according to the first embodiment;

FIG. 9 is a schematic plan view showing a configuration of a speaker apparatus according to another embodiment;

FIG. 10 is a schematic plan view showing a configuration of a speaker apparatus according to another embodiment;

FIG. 11 is a schematic plan view showing a configuration of a speaker apparatus according to another embodiment;

FIG. 12 is a schematic plan view showing a configuration of a speaker apparatus according to another embodiment;

FIG. 13 is a schematic plan view showing a configuration of a speaker apparatus according to another embodiment;

FIG. 14 is a schematic plan view showing a configuration of a speaker apparatus according to another embodiment; and

FIG. 15 is a schematic plan view showing a configuration of a speaker apparatus according to another embodiment.

### DETAILED DESCRIPTION

### Background to Occurrence of Problem

### <Configuration of Speaker Apparatus According to General Technique>

Hereinafter, a background to occurrence of a problem to be solved by the present invention will be described with reference to the drawings. First, a configuration of a general speaker apparatus will be described in detail.

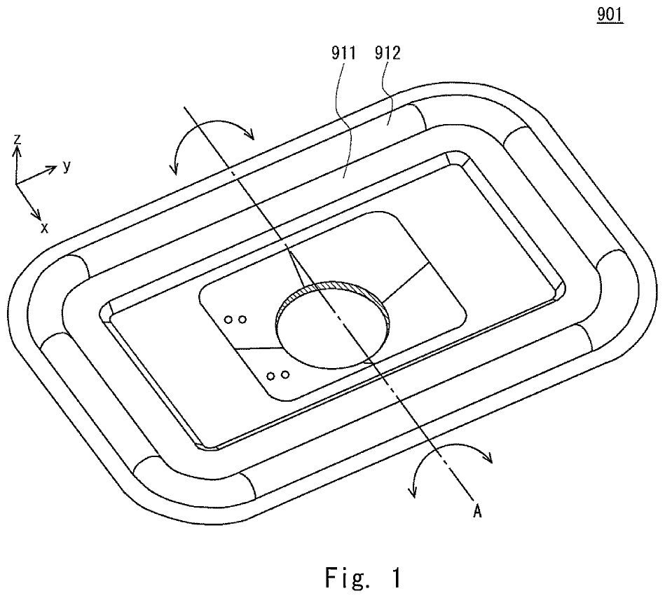

FIG. 1 is a perspective view showing a speaker apparatus according to a related art. Additionally, only parts that are related to occurrence of a problem to be solved by the present application are shown. More specifically, only a diaphragm and outer peripheral parts thereof are shown.

A speaker apparatus 901 according to the related art includes a diaphragm 911, an edge 912, a frame 913, and a magnetic circuit, a voice coil bobbin, a damper, an input terminal and the like that are not shown.

The magnetic circuit is housed inside the frame. The voice coin bobbin around which a voice coil copper wire is wound is disposed in a magnetic field that is generated by the magnetic circuit. A voice coil causes the voice coil bobbin to vibrate in a winding axis direction of the voice coil, or in other words, a sound emission direction, due to Lorentz force that is generated by the magnetic field and a current input from the input terminal that is electrically connected. The voice coil bobbin is connected to the damper, an outer periphery of which is fixed to the frame.

Additionally, a right-handed XYZ orthogonal coordinate system shown in FIG. 1 is for describing a positional relationship among structural elements, and the sound emission direction of the speaker apparatus 901 is given as a Z-axis, and a short axis direction and a long axis direction of the diaphragm are given as an X-axis and a Y-axis, respectively. Same directions are used in the following drawings.

The diaphragm 911 is a plate made of resin, metal, or the like. More specifically, the diaphragm 911 is connected to the voice coil bobbin, and is vibrated in the sound emission direction, or in other words, in a Z-axis direction, according to vibration of the voice coil bobbin to generate sound.

When normally operating, the diaphragm 911 vibrates in the Z-axis direction while maintaining a main surface of the diaphragm 911 parallel to an XY-plane.

The diaphragm 911 is supported by the frame 913 via the edge 912.

The edge 912 is an annular member provided on an outer circumference of the diaphragm, and is formed from an elastic material such as rubber.

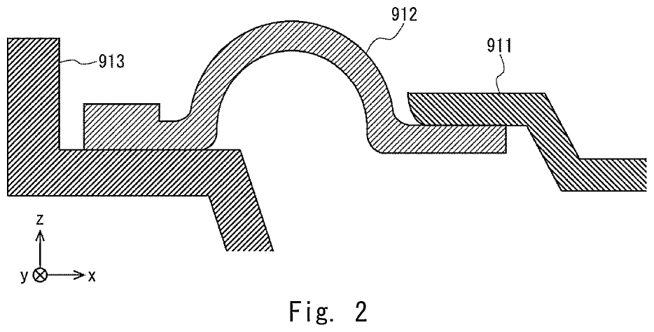

FIG. 2 is a schematic cross-sectional view for describing a shape of the edge 912 according to the related art, and is more specifically an enlarged view of the edge 912 and its periphery based on a schematic cross-sectional view obtained by cutting the edge 912 along an XZ-plane passing through a speaker center axis.

As shown in FIG. 2, a cross-sectional shape of the edge 912 is a semicircular shape. An outer edge portion of the edge 912 is bonded and fixed to the frame 913, and an inner edge portion is bonded to the diaphragm. That is, the outer edge portion of the edge 912 is a fixed edge, and the inner edge portion is a free edge. The edge 912 can follow movement of the diaphragm 911 in the Z-axis direction without interfering with the movement.

The outer edge portion of the edge 912 is fixed to the frame 913, and the frame 913 supports the diaphragm 911 via the edge 912.

The frame 913 houses the diaphragm 911 of the speaker apparatus 901, the edge 912, and the magnetic circuit, the voice coil bobbin, the damper, the input terminal and the like that are not shown.

### <Rolling Motion of Diaphragm>

Next, a rolling motion of the diaphragm will be described. Additionally, in the following description, FIG. 1 or 2 is referred to as appropriate.

As described above, in a state where the speaker apparatus 901 is normally operating, the diaphragm 911 vibrates in the Z-axis direction while maintaining the main surface of the diaphragm 911 parallel to the XY-plane.

However, at the time of vibration of the diaphragm, a phenomenon called a rolling motion may occur where a vibration component in a different direction from the Z-axis direction is added at a specific frequency due to unbalancedness in weight or support. Particularly, a rolling motion in a specific direction when the unbalancedness is great is referred to as a seesaw motion.

For example, with the diaphragm 911 as shown in FIG. 1 that is long and narrow in a Y-axis direction, the diaphragm 911 possibly vibrates while performing the seesaw motion in the Y-axis direction with a center axis A of the diaphragm 911 in an X-axis direction as a rotation axis.

When the diaphragm 911 performs the seesaw motion, an abnormal sound gets mixed in with sound that is generated by the speaker apparatus 901. Moreover, when a component of the seesaw motion becomes great, the edge 912 may tear, or the speaker apparatus 901 may get damaged due to the voice coil bobbin trembling and coming into contact with the magnetic circuit.

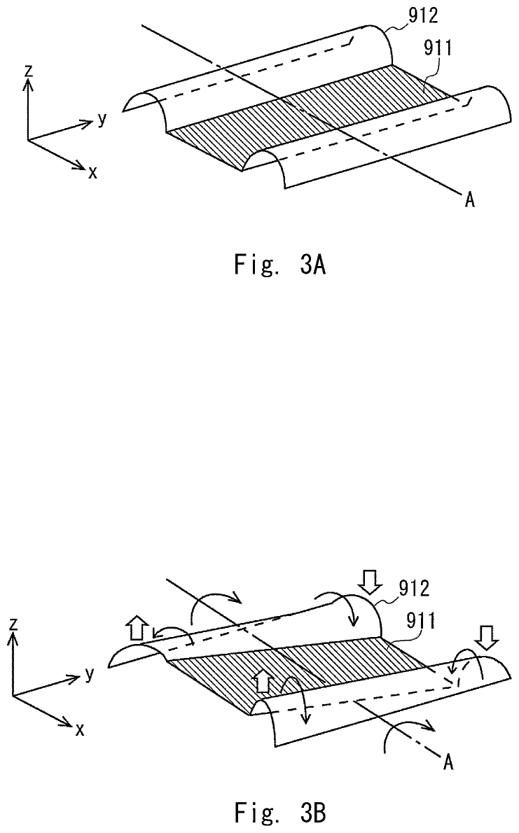

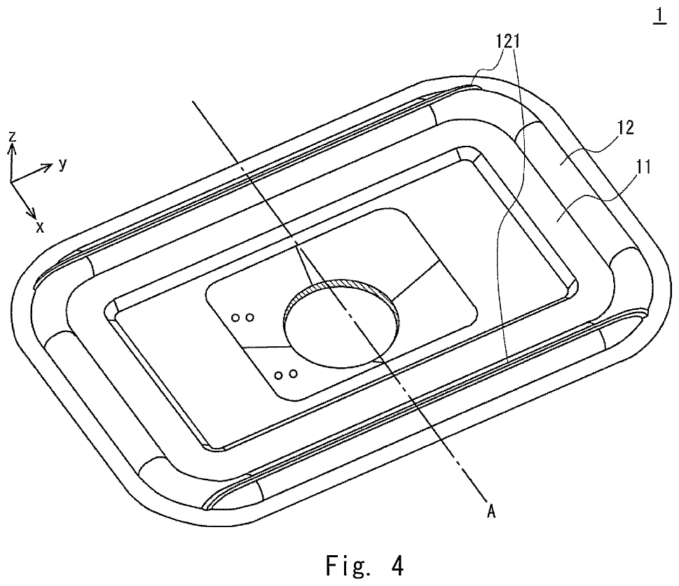

FIG. 3A and FIG. 3B are schematic perspective views for describing the seesaw motion of the diaphragm.

FIG. 3A and FIG. 3B schematically show only the diaphragm 911 and parts of the edge 912 that are orthogonal to the center axis A. Moreover, the main surface of the diaphragm 911 is hatched, and is shown as a horizontal surface.

FIG. 3A shows a state where the diaphragm 911 is still. In a still state, the main surface of the diaphragm 911 is parallel to the XY-plane. Furthermore, in the state where the diaphragm 911 is normally operating, the diaphragm 911 vibrates in the Z-axis direction while maintaining the main surface parallel to the XY-plane.

FIG. 3B is a first diagram showing a state where the diaphragm 911 is performing the seesaw motion. For example, a state is shown where the center axis A is taken as a rotation axis, and the diaphragm 911 is rotating clockwise when seen from an X-axis positive side.

With the diaphragm that is long and narrow in the Y-axis direction, a seesaw motion tends to occur where clockwise rotational displacement and counterclockwise rotational displacement are repeatedly performed with the center axis A in the X-axis direction as the rotation axis. When vibration balance is impaired due to addition of a small force in other than the Z-axis direction, an oscillation state where the seesaw motion continues may occur.

When focusing on a motion of the edge 912 in FIG. 3B, a part on a Y-axis negative direction side relative to the center axis A rises in a Z-axis positive direction, and a part on a Y-axis positive direction side relative to the center axis A falls in a Z-axis negative direction. That is, when the diaphragm 911 performs the seesaw motion, the edge 912 is deformed in such a manner that an amount of deformation in the Z-axis direction is different between two ends in the Y-axis.

Moreover, when focusing on bending of the edge 912, the part on the Y-axis negative direction side relative to the center axis A is twisted and bent in an outer edge direction, and the part on the Y-axis positive direction side relative to the center axis A is twisted and bent in an inner edge direction. That is, when the diaphragm 911 performs the seesaw motion, the edge 912 is deformed into a shape that is twisted around the Y-axis. A restoring force for undoing twist is applied to the edge 912, but is too weak to be a suppression force for the seesaw motion in the oscillation state and is not able to suppress the seesaw motion.

### Outline of Embodiment

In the case where the diaphragm performs the seesaw motion in the manner described above, the edge 912 does not interfere with but follows the motion of the diaphragm 911 in the Z-axis direction, but does not function to restrict the diaphragm 911 to vibrate only in the Z-axis direction, and to suppress the seesaw motion.

Accordingly, with a speaker apparatus according to an embodiment described below, a reinforcement part whose end portions are connected to a frame is provided on the edge so as to suppress the seesaw motion without preventing motion of a diaphragm in the sound emission direction.

### First Embodiment

In the following, a first embodiment of the present invention will be described with reference to the drawings.

FIG. 4 is a perspective view showing a speaker apparatus according to the first embodiment. Additionally, only parts that are related to occurrence of the problem to be solved by the present application are shown. More specifically, only a diaphragm and outer peripheral parts thereof are shown.

Additionally, a right-handed XYZ orthogonal coordinate system shown in FIG. 4 is for describing a positional relationship among structural elements, and the sound emission direction of a speaker apparatus 1 is given as a Z-axis, and a short axis direction and a long axis direction of the diaphragm are given as an X-axis and a Y-axis, respectively. Same directions are used in the following drawings.

The speaker apparatus 1 according to the first embodiment includes a diaphragm 11, an edge 12, a frame 13, reinforcement parts 121, and a magnetic circuit, a voice coil bobbin, a damper, an input terminal and the like that are not shown.

The diaphragm 11 is a plate made of resin, metal, or the like. More specifically, the diaphragm 11 is connected to the voice coil bobbin, and is vibrated in the sound emission direction according to vibration of the voice coil bobbin to generate sound. When normally operating, the diaphragm 11 vibrates in the Z-axis direction while maintaining a main surface of the diaphragm 11 parallel to an XY-plane. The diaphragm 11 is supported by the frame 13 via the edge 12.

An outer edge portion of the edge 12 is fixed to the frame 13, and the frame 13 supports the diaphragm 11 via the edge 12. The frame 13 houses the diaphragm 11 of the speaker apparatus 1, the edge 12, and the magnetic circuit, the voice coil bobbin, the damper, the input terminal and the like that are not shown.

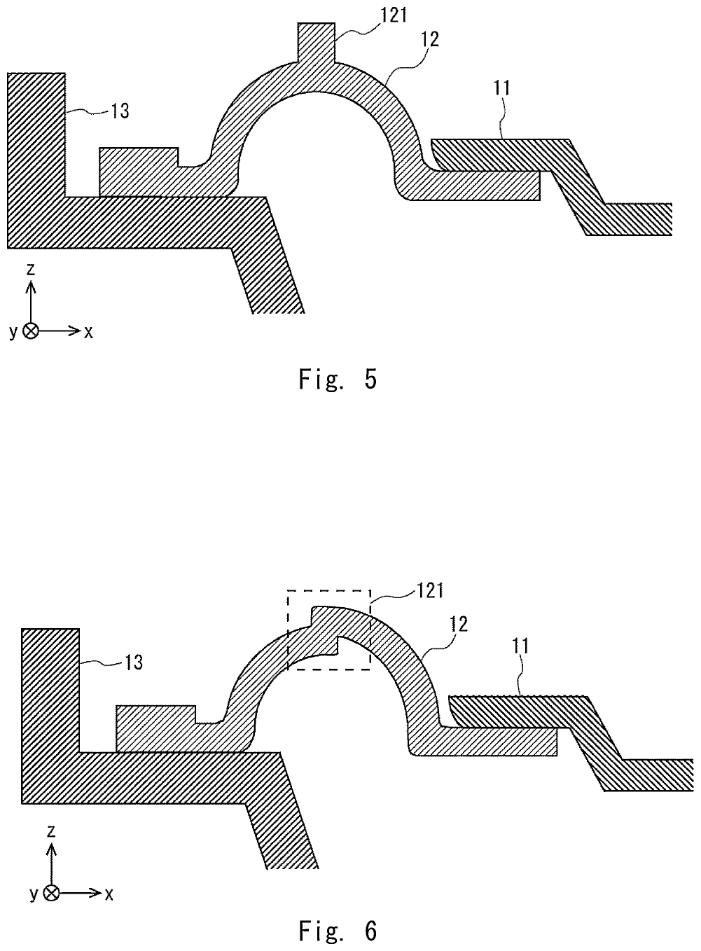

The edge 12 is an annular member provided on an outer circumference of the diaphragm, and is formed from an elastic material such as rubber. FIG. 5 is a schematic cross-sectional view for describing a shape of the edge 12 according to the first embodiment.

As shown in FIG. 5, a cross-sectional shape of the edge 12 is a semicircular shape. The outer edge portion of the edge 12 is bonded and fixed to the frame 13, and an inner edge portion is bonded to the diaphragm. That is, the outer edge portion of the edge 12 is a fixed edge, and the inner edge portion is a free edge. The edge 12 can follow movement of the diaphragm 11 in the Z-axis direction without interfering with the movement.

The edge 12 includes the linear reinforcement parts 121 that extend in a circumferential direction of the edge 12. The circumferential direction here is a direction along the annular edge around the Z-axis.

The reinforcement part 121 is formed from a linear portion that extends in the circumferential direction of the edge 12, and end portions that are at ends of the linear portion and that are each connected and fixed to the frame 13 at the outer edge portion. A material of the reinforcement part 121 may be a material having equal or higher rigidity than a material of the edge 12.

The linear portion of the reinforcement part 121 is linearly disposed on the edge 12, and increases rigidity of the edge 12 in the circumferential direction.

The end portion of the reinforcement part 121 is fixed to the frame 13 at the outer edge portion while maintaining high flexural rigidity in the circumferential direction of the edge 12, and holds the linear portion of the reinforcement part 121 parallel to the XY-plane.

According to such a configuration, the reinforcement part 121 is able to suppress rotational displacement of the diaphragm 11 around a center axis A, or in other words, the seesaw motion.

The linear portion that forms most of the reinforcement part 121 extends in the circumferential direction of the edge 12, but does not extend in a radial direction of the edge 12. Accordingly, the reinforcement part 121 increases rigidity of the edge 12 in the circumferential direction, but does not increase rigidity of the edge 12 in the radial direction.

According to such a configuration, the reinforcement part 121 may suppress the seesaw motion of the diaphragm 11 while minimizing a blocking effect of an inner-edge end portion of the edge 12 connected to the diaphragm 11 on vibration in the Z-axis direction. That is, the reinforcement part 121 may suppress the seesaw motion of the diaphragm 11 while minimizing the blocking effect on a vibration motion of the diaphragm 11 in the Z-axis direction.

As shown in FIG. 5, the reinforcement part 121 may be formed from a rib that is integrally molded with the edge 12, and end portions, at ends of the rib, that are connected and fixed to the frame 13 at the outer edge portion along a semicircle of the edge. According to such a configuration, a part where the reinforcement part 121 is formed has an increased thickness, and higher rigidity than a part where the reinforcement part 121 is not formed.

Additionally, a shape of an end portion of the rib of the reinforcement part 121 in the Z-axis direction is not limited to a rectangular shape as shown in FIG. 5, and may be a triangular shape or an arc shape, for example.

The linear portion of the reinforcement part 121 that extends on a long axis part of the edge 12 is not limited to the rib that is integrally molded with the edge 12, and may instead be a step that extends along the circumferential direction of the edge 12, as shown in FIG. 6, for example. In this case, the reinforcement part 121 is formed from a linear portion that is formed as a linear step, and end portions, at both ends of the linear portion, that are connected and fixed to the frame 13 at the outer edge portion. More specifically, the edge 12 is formed from two surfaces with different radii that protrude outward in a radial direction from a center of radius of the semicircular edge 12, and the linear portion of the reinforcement part 121 is formed as a step that extends in the circumferential direction of the edge 12, the step being a ridge or a step surface where surfaces with different radii are connected. Also in the case where the linear portion of the reinforcement part 121 is a step formed on the edge 12, as in the case where the reinforcement part 121 includes a rib, the reinforcement part 121 increases rigidity of the edge 12 in the circumferential direction and is thus able to suppress the seesaw motion of the edge 12.

The step of the reinforcement part 121 may be formed by two ridges connected to a semicircular roll positioned on an inner side of the edge 12 in a radial direction and having a first radius and a semicircular roll positioned on an outer side of the edge 12 in the radial direction and having a second radius, and a step surface formed between the two ridges.

In this case, a size relationship between the first radius and the second radius may be such that the first radius is greater or the second radius is greater, but it is preferable if the first radius is greater.

A greater radius of the roll results in a smaller blocking effect on the vibration of the diaphragm 11 in the Z-axis direction, and thus, in the case where the first radius is greater, or in other words, in the case where the roll with the greater radius is disposed on the inner side of the edge 12 in the radial direction where the diaphragm 11 is present, the blocking effect on the vibration of the diaphragm 11 in the Z-axis direction can be suppressed.

Additionally, the outer side of the edge 12 in the radial direction is fixed to the frame 13 and is not directly connected to the diaphragm 11, and thus, even when the roll with the smaller radius is disposed, the blocking effect on the vibration of the diaphragm 11 in the Z-axis direction is small.

Additionally, the first radius and the second radius may be the same. In this case, the reinforcement part 121 may be formed as a step surface or a ridge where the semicircular rolls are connected in a shifted manner with centers of arcs of the rolls being shifted from each other.

In the case where the linear portion of the reinforcement part 121 is formed as a step, the edge 12 may be assumed to have a bowl shape where the semicircular roll portion having the second radius is taken as a bottom portion and the step surface with increased rigidity and an outer edge portion of the reinforcement part 121 are taken as a side portion.

Moreover, the semicircular roll having the first radius that is connected to a top edge of the step surface may be assumed to be a flange at the top edge of the step surface. Rigidity of the edge 12 in the circumferential direction is further increased by the flange.

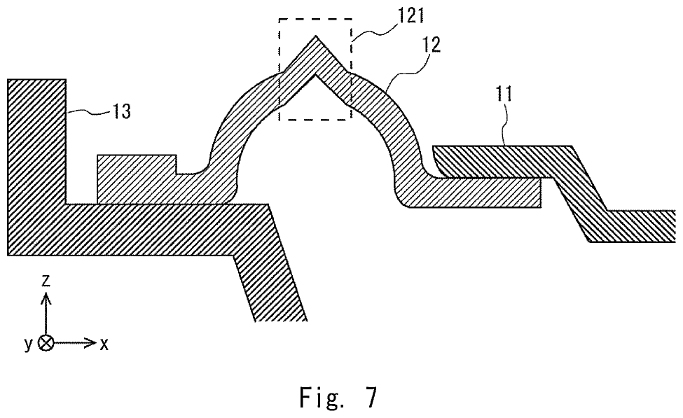

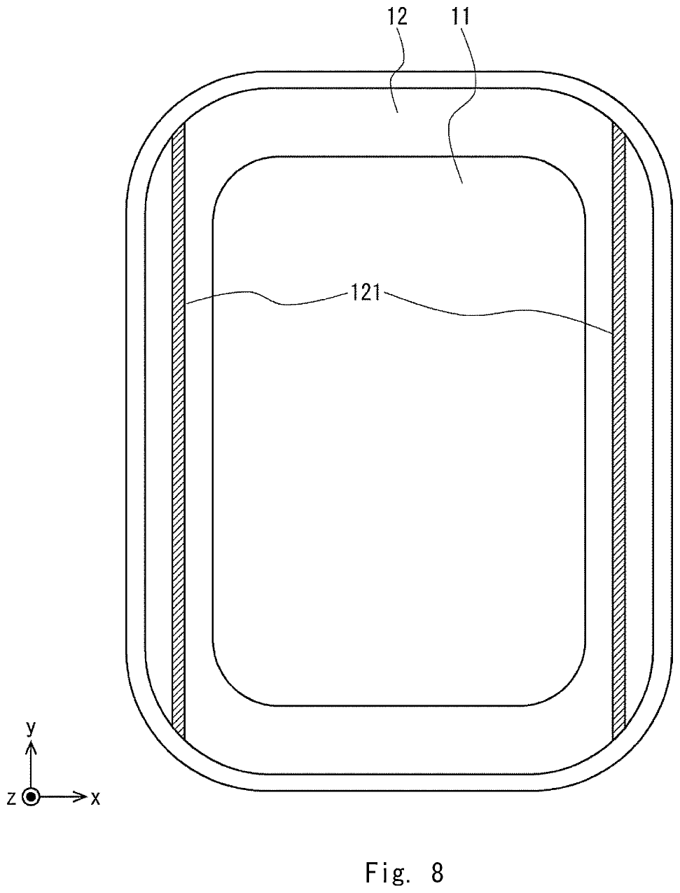

For example, as shown in FIG. 7, the linear portion of the reinforcement part 121 extending on the long axis part of the edge 12 may be a crease that extends along the circumferential direction of the edge 12. In this case, the edge 12 is formed as two annular surfaces that are disposed on the inner side and the outer side in the radial direction, and a corner part where the surfaces are joined makes a ridge or the crease corresponding to the reinforcement part 121.

Furthermore, in the case where the reinforcement part 121 is formed as a crease, the reinforcement part 121 may have a concave shape when seen from a Z-axis positive side.

Furthermore, the reinforcement part 121 may be formed by sticking, to the edge 12, a linear member that is formed from a material having higher rigidity than the edge 12. Also in this case, two end portions extend to the outer edge portion of the edge 12 to be bonded and fixed to the frame 13.

Moreover, the reinforcement part 121 may be disposed on a side opposite the sound emission direction, or in other words, on an inside of the semicircular edge 12. When disposed on the side opposite the sound emission direction, the reinforcement part 121 is hidden inside the speaker apparatus 1, and a speaker apparatus with a good external appearance may be provided.

Furthermore, the linear portion of the reinforcement part 121 is preferably disposed at approximately a top part of the semicircle that is a cross-section of the edge 12, but the linear portion may instead be disposed shifted toward an inner edge side or an outer edge side of the edge 12.

In the case where the linear portion is shifted toward the inner edge side of the edge 12, a distance from a fixed part of the end portion, or in other words, a part connected to the frame 13, becomes great. Accordingly, compared to a case where the linear portion is approximately at a top of the semicircular shape of the edge 12, a resistance force in the Z-axis direction at the end portion is reduced.

Furthermore, in the case where the linear portion is shifted toward the outer edge side of the edge 12, the distance from the fixed part of the end portion, or in other words, the part connected to the frame 13, becomes small. Accordingly, compared to the case where the linear portion is approximately at the top of the semicircular shape of the edge 12, the resistance force in the Z-axis direction at the end portion is increased.

Additionally, not all part of the reinforcement part 121 has to extend in the circumferential direction, and it suffices if at least a part thereof extends in the circumferential direction of the edge 12. To suppress the seesaw motion, the reinforcement part 121 desirably extends in the circumferential direction of the edge 12 over a greater range than a diameter of the voice coil bobbin, not shown.

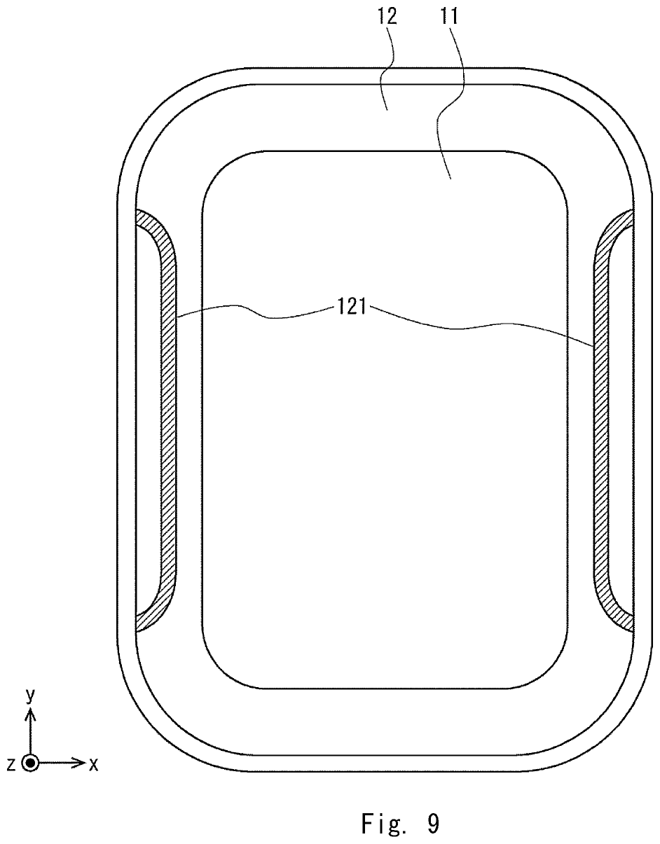

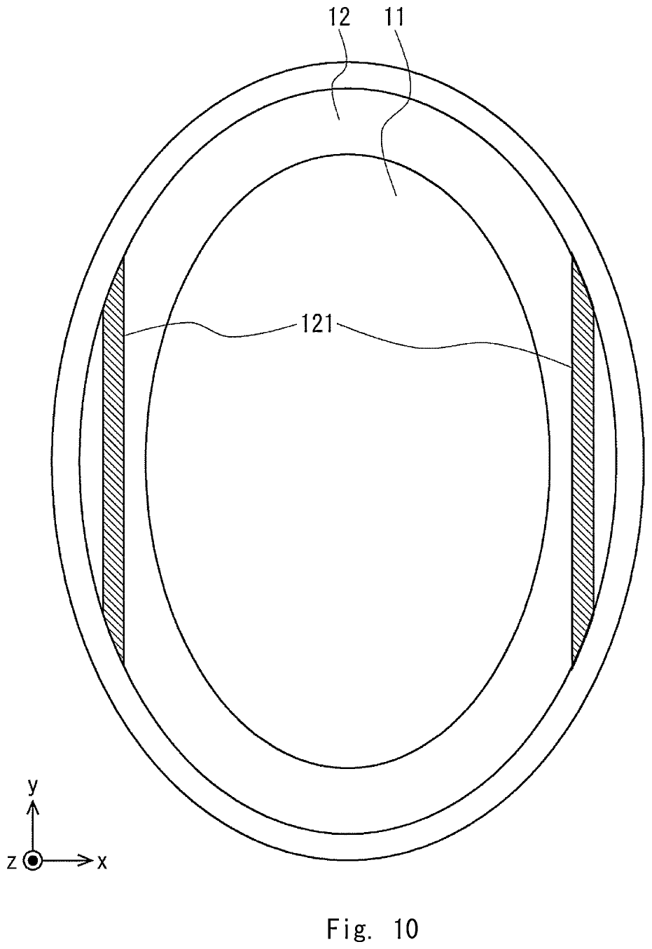

In the case where the edge 12 has a shape that includes long axis portions, short axis portions, and curved portions that connect the long axis portions and the short axis portions, the reinforcement part 121 may extend linearly on the long axis portions and the curved portions as shown in FIG. 8. Furthermore, two end portions of the reinforcement part 121 may be connected to the outer edge portion of the edge 12 at the long axis portion, as shown in FIG. 9. In other words, the two end portions of the reinforcement part 121 may each be connected and fixed to the outer edge portion of the edge 12 without reaching the curved portion of the edge 12.

When seen from the Z-axis direction, curvature of the edge is great at the curved portion connecting the long axis portion and the short axis portion, and thus, the curved portion is distorted in shape at the time of driving. The greater the curvature seen from the Z-axis direction, the more distortion is concentrated at the curved portion in relation to the shape at the time of driving. When distortion in shape concentrates at the curved portion, a resistance occurs at the curved portion at a timing when the edge 12 follows the vibration of the diaphragm 11. Accordingly, a part where the curvature seen from the Z-axis direction is great can be said to be a part where a resistance is easily generated and that is not easily moved.

When the reinforcement part 121 is provided at a position where the curvature seen from the Z-axis direction is great, concentration of distortion in shape at the time of driving occurs due to the reinforcement part 121, and normal vibration of the diaphragm 11 in the Z-axis direction is obstructed. Accordingly, as described above, the part of the edge 12 where the reinforcement part 121 is provided is desirably a position with a small curvature when seen in the sound emission direction of the diaphragm 11.

In the present embodiment, two reinforcement parts 121 are present at positions that face each other across the diaphragm 11, but instead, the number of reinforcement parts 121 provided on the edge 12 may be one. However, providing two reinforcement parts 121 on the edge 12 achieves a good structural balance, and the seesaw motion may be better suppressed.

As described above, the linear portion of the reinforcement part 121 increases rigidity of the edge 12 in the circumferential direction, and the end portions of the reinforcement part 121 maintain the linear portion parallel to the XY-plane, and thus, the speaker apparatus 1 according to the present embodiment is able to suppress the seesaw motion of the diaphragm 11. As a result, the speaker apparatus 1 is able to suppress the rolling motion of the diaphragm 11.

### Other Embodiments

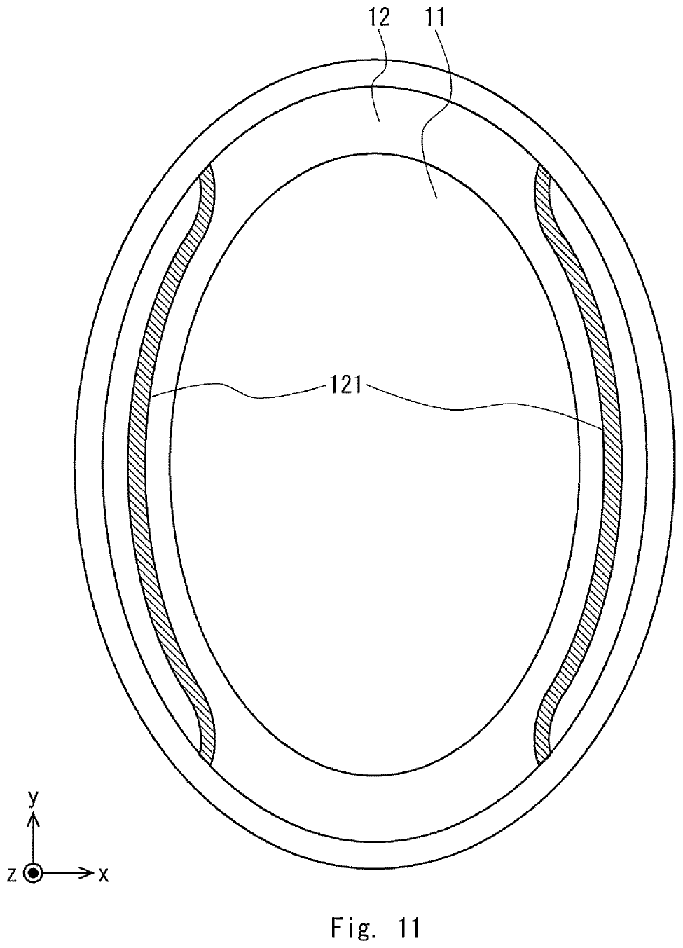

FIGS. 10 and 11 are schematic plan views showing configurations of a speaker apparatus according to another embodiment.

The diaphragm 11, the edge 12, and the frame 13 according to the first embodiment are rectangular-shaped when seen in the sound emission direction, but the diaphragm 11, the edge 12, and the frame 13 according to the present invention may instead be oval-shaped when seen in the sound emission direction.

As shown in FIG. 10, when the diaphragm 11, the edge 12, and the frame 13 are oval-shaped, the reinforcement part 121 may extend linearly in the circumferential direction of the oval-shaped edge 12. Furthermore, as shown in FIG. 11, the reinforcement part 121 may extend in the circumferential direction of the oval-shaped edge 12, with the end portions being fixed to the frame 13 at the outer edge portion of the edge 12.

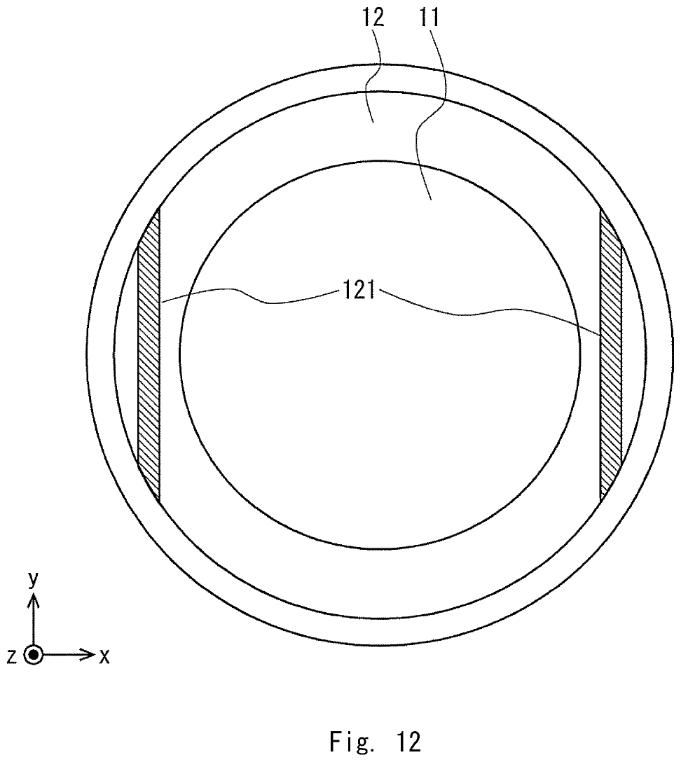

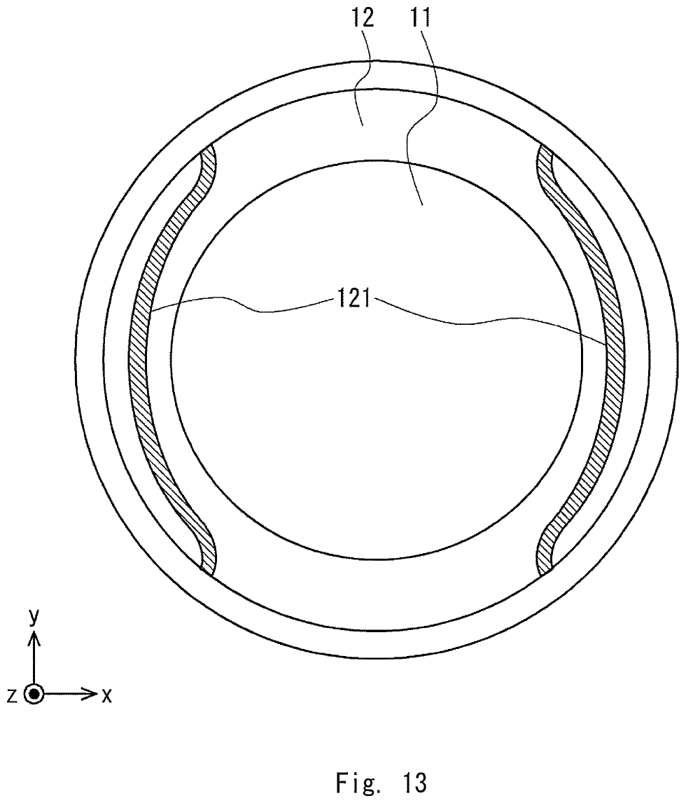

FIGS. 12 and 13 are schematic plan views showing configurations of a speaker apparatus according to another embodiment.

The diaphragm 11, the edge 12, and the frame 13 according to the first embodiment are rectangular-shaped when seen in the sound emission direction of the diaphragm 11, but the diaphragm 11, the edge 12, and the frame 13 according to the present invention may instead be circular-shaped when seen in the sound emission direction.

In such a case, the reinforcement part 121 may extend linearly in the circumferential direction of the circular-shaped edge 12, as shown in FIG. 12. Furthermore, as shown in FIG. 13, the reinforcement part 121 may extend in the circumferential direction of the circular-shaped edge 12, with the end portions being fixed to the frame 13 at the outer edge portion of the edge 12.

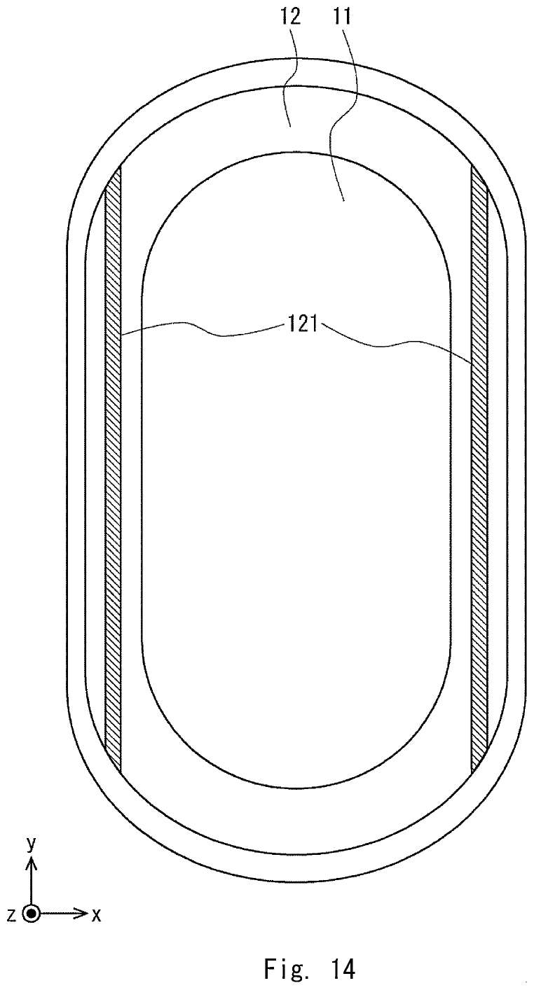

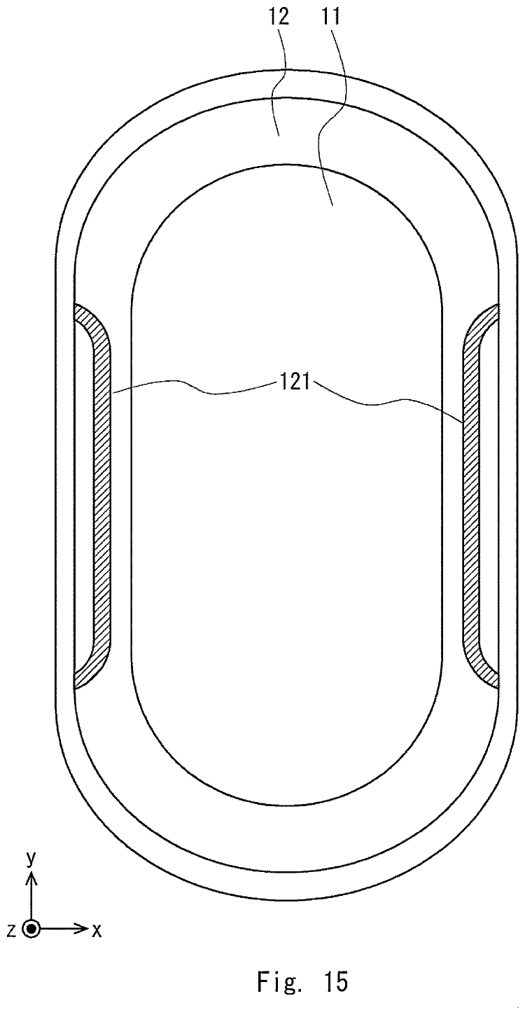

FIGS. 14 and 15 are schematic plan views showing configurations of a speaker apparatus according to another embodiment.

The diaphragm 11, the edge 12, and the frame 13 according to the first embodiment are rectangular-shaped when seen in the sound emission direction of the diaphragm 11, but the diaphragm 11, the edge 12, and the frame 13 according to the present invention may instead be running track-shaped when seen in the sound emission direction.

In such a case, the edge 12 is formed from two pairs of straight line portions facing each other across the diaphragm 11, and curved portions that connect the straight line portions. As shown in FIG. 14, the reinforcement part 121 may linearly extend on the rectangular-shaped edge 12. Furthermore, as shown in FIG. 15, the reinforcement part 121 may extend in the circumferential direction along the long axis direction of the rectangular-shaped edge 12, with the end portions being fixed to the frame 13 at the outer edge portion of the edge 12 at the straight line portion of the edge 12 in the long axis direction.

As shown in FIG. 14, in the case where the reinforcement part 121 that is curved is connected to the frame 13 at the straight line portion of the edge 12, blocking effect on normal vibration of the diaphragm 11 may be better suppressed.

By contrast, as shown in FIG. 15, in the case where the reinforcement part 121 that is straight is connected to the frame 13 at the curved portions of the edge 12, the rolling motion may be better suppressed.

Heretofore, the present invention has been described with reference to the embodiments, but the present invention is not limited to the configurations of the embodiments described above, and various modifications, alterations, and combinations that can be devised by those skilled in the art within the scope of the invention described in the claims of the present application are of course included.

According to the present embodiment, a speaker apparatus that is capable of suppressing the rolling motion of a diaphragm can be provided.

The first and other embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A speaker apparatus comprising:
an edge provided around a diaphragm;
a frame configured to support the diaphragm via the edge; and
a reinforcement part provided on the edge, the reinforcement part including a linear portion and two end portions,
wherein the linear portion of the reinforcement part extends in a circumferential direction of the edge, and the two end portions of the reinforcement part are connected to the frame.

2. The speaker apparatus according to claim 1, wherein
the edge includes a long axis portion and a short axis portion, and
the two end portions are connected to the frame at the long axis portion.

3. The speaker apparatus according to claim 1, wherein a material of the reinforcement part has higher rigidity than a material of the edge.

4. The speaker apparatus according to claim 1, wherein the linear portion is a rib.

5. The speaker apparatus according to claim 1, wherein the linear portion is a step.
